(19) United States
(12) Patent Application Publication
(10) Pub. No.: US 2016/0106071 A1
(43) Pub. Date: Apr. 21, 2016

(54) FEEDER

(71) Applicant: Victor William Gough, Lowood (AU)

(72) Inventor: Victor William Gough, Lowood (AU)

(21) Appl. No.: 14/887,671

(22) Filed: Oct. 20, 2015

(30) Foreign Application Priority Data
Oct. 21, 2014 (AU) 2014101284

(51) Int. Cl. A01K 39/012

(52) U.S. Cl. CPC A01K 39/012

(57) ABSTRACT

A feeder is provided with a receptacle, an open trough and a bar or plurality of bars, which is adapted to regulate the rate of feed being available to livestock. This feeder encourages livestock to eat in their natural position, ensures that the feed does not irritate the livestock's eyes, and alleviates problems associated with feed falling to the floor.

### RELATED APPLICATION

This application claims priority of Australia Patent No. 2014101284, filed Oct. 21, 2014, the entirety of which is here by incorporated by reference for all purposes.

### FIELD OF INVENTION

The present invention relates to the field of animal husbandry. More particularly this invention relates to a feeder for dispensing feed to grazing animals.

### BACKGROUND TO THE INVENTION

Any reference to background art herein is not to be construed as an admission that such art constitutes common general knowledge in Australia or elsewhere.

Caring for any annual involves feeding them and making sure they have enough nutrition to keep them functioning healthily. Many livestock farmers use feeders to regulate the amount of feed that is supplied to and consumed by an animal, in particular grazing animals. Sometimes animals can consume great quantities of food in a short period of time and this may result in colic. Colic in horses can be problematic because of the obstruction in the intestines and can lead to death. Among domesticated horses, colic is the leading cause of premature death and it is estimated that colic affects between 4-10% of horses over the course of their lifetime.

Another form of colic is sand impaction which occurs when horses graze on sandy or over grazed pastures. The sand and dirt ingested can accumulate in the colon and large intestines, and this can cause irritation, inflammation or death. Many instances of colic arise from feed being dropped on the ground and the grazing animals ingesting sand and dirt with the feed. Current feeders are inefficient because the feed can fall from the feeders to the ground.

In nature, livestock eat vegetation from the ground or near the ground. For example, a horse will typically lower its head to reach the vegetation and then lift its head to chew and swallow. This action of putting their head down and coming up to swallow ensures that the horse does not ingest the food too quickly. Current feeders do not encourage livestock to eat in a natural position; instead because the feeder is in a raised position the livestock may eat and swallow in the same position, allowing the rapid consumption of feed. Further to this, it would be advantageous to find a way of feeding livestock that mimics their natural behaviour.

### OBJECT OF THE INVENTION

It is an aim of this invention to provide a feeder that results in less feed being dropped on the ground, can regulate the amount of feed supplied and is orientated to encourage livestock to eat in their natural position.

In this specification, words such as “comprise”, “comprises”, “comprising” or “include”, “includes”, “including” or “selected” are intended to define a non-exclusive inclusion, such that a process, method article, or apparatus that comprises a list of elements does not include only those elements, but may include other elements not expressly listed, including elements that are inherent to such a process, method, article, or apparatus.

In one form, although it need not be the only or indeed the broadest form, the invention resides in a feeder comprising:

a. a receptacle having a front wall, a rear wall and two side walls joining the front wall and the rear wall to enclose a receptacle chamber; and
b. an open trough projecting outwardly beyond the front wall from a lower end of the receptacle and continuous with the receptacle chamber,
wherein the front wall is a solid panel preventing access therethrough to the receptacle chamber.

The solid panel may be made out of a single material or may be a composite of different materials. The rear wall and two side walls may be also be a solid panel which prevents access therethrough to the receptacle chamber. The rear wall and the two side walls may also be made out of a single material or may be a composite of different materials.

The receptacle, the open trough and bar or plurality of bars can be made of one or more materials which can be selected from the group consisting of plastic or any metal selected from the group consisting of steel, alloys, stainless steel galvanized iron and aluminium.

In one embodiment, the feeder may comprise a bar or a plurality of bars. The number of bars is suitably selected from 1 to 10, and preferably selected from 2, 3, or 4 and most suitably 3. The bar or plurality of bars covers the area between a lower end of the front wall, adjacent the open trough, and an outer extent of the open trough.

The receptacle may have an open upper extent continuous with the receptacle chamber. The receptacle may further comprise a structure that encloses the receptacle chamber. Such structures may comprise a lid, where the lid may be attached or unattached to an upper extent of the receptacle.

The rear wall may comprise a fastener. The fastener may project from the rear wall. Fasteners are well known in the art and can comprise a hook or a clip which can couple to a complimentary fastener, such as a bar or rail. The fastener may further comprise a male portion which can couple with a complimentary fastener such as a female portion.

Preferably, the feeder is for grazing animals.

Throughout the specification the aim has been to describe the one embodiment or specific collection of features. It will therefore be appreciated by those of skill in the art that, in light of the instant disclosure, various modifications and changes can be made in the particular embodiments exemplified without departing from the scope of the present invention.

### BRIEF DESCRIPTION OF THE FIGURES

In order that the invention may be readily understood and put into practical effect, preferred embodiments will now be described by the way of examples with reference to the accompanying figures where:

FIG. 1 illustrates a perspective view of the feeder;

FIG. 2 illustrates a rear view of the feeder; and

FIG. 3 illustrates a side view of the feeder.

### DETAILED DESCRIPTION OF THE INVENTION

The present invention relates to a feeder comprising a receptacle, an open trough, and a bar or plurality of bars capable of regulating the amount of feed supplied to a grazing animal. The present invention alleviates the problem of feed dropping on the ground and also encourages a grazing animal to eat in its natural eating position. The present invention is also safer by fully enclosing the feed, by not allowing strands of hay to protrude from the front of the feeder and thus protects the livestock's eyes.

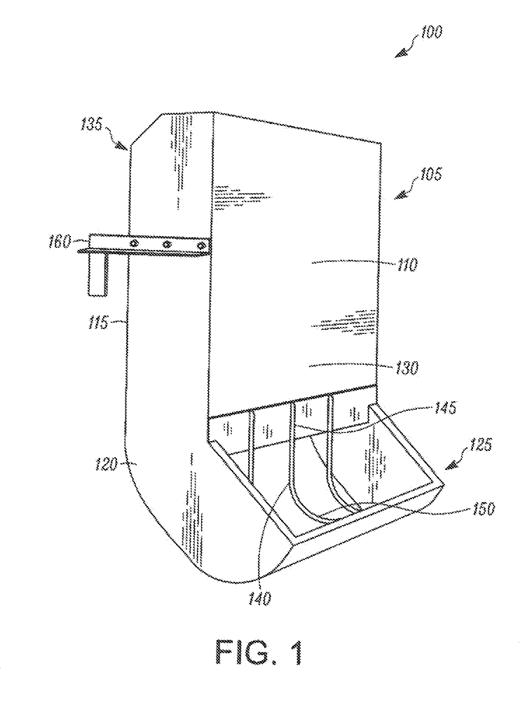

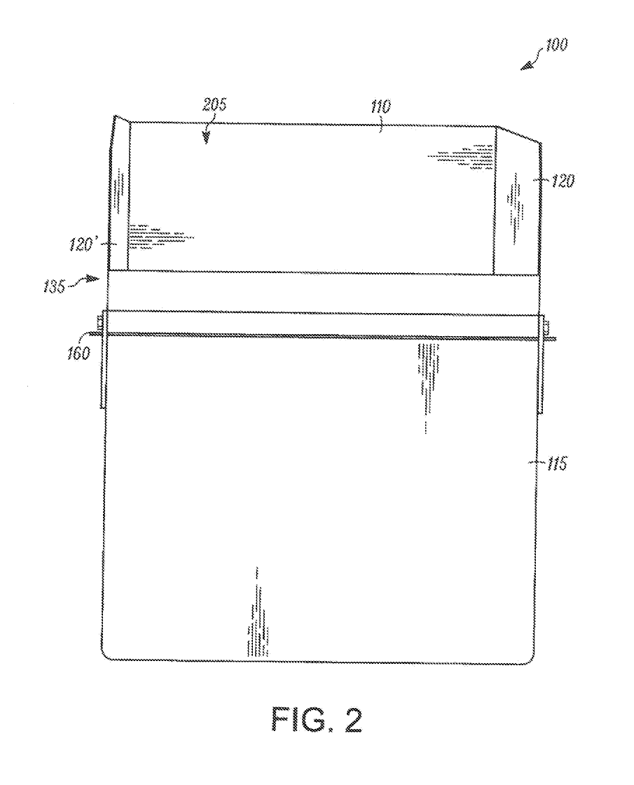

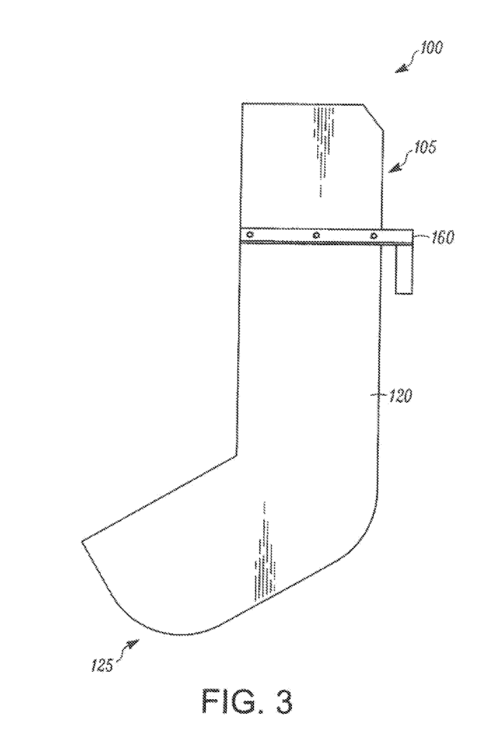

Referring to FIG. 1, FIG. 2 and FIG. 3, there is shown a feeder 100. The feeder 100 comprises a receptacle 105 having a front wall 110, a rear wall 115 and two side walls, 120 and 120′, joining the front wall 110 and the rear wall 115 to form a receptacle chamber. An open trough 125 projects outwardly beyond the front wall 110 from the lower end of the receptacle 130 and is continuous with the receptacle chamber. The front wall 110 is a solid panel preventing access therethrough to the receptacle chamber.

The receptacle chamber acts to store the feed so an operator is not required to constantly refill the trough 125 to ensure that the grazing animal has enough feed. It will be appreciated that the dimensions of the receptacle 305 can be altered to increase or decrease the volume of the receptacle 105 and receptacle chamber. It will also be appreciated that the dimensions of the receptacle 105 can be altered to fit into the intended area of use and also the type of livestock to be fed.

The term “solid panel” used herein refers to a sheet of material that is complete, unbroken, intact, uninterrupted, continual, continuous or sealed and does not allow access therethrough to the contents of the receptacle chamber. It will be appreciated that the solid panel may be embodied as a single panel, but also may be embodied by the combination of multiple panels made of one or more materials. These multiple panels may be combined by welding them together, interlocking, or joining using methods known in the art. Typical feeders do not utilize a solid sheet to enclose the front of the receptacle chamber. Instead the front wall is embodied as a grille, and livestock can gain access to the feed through this grille. Protruding hay stalks can poke or fall into the livestock's eyes and cause irritation, inflammation and even blindness. The solid panel of the present invention keeps the feed, e.g., hay, from protruding out of the front wall 310 and protects the eyes of the livestock.

The receptacle, the open trough and bar or plurality of bars can be made of one or more materials which can be selected from the group consisting of plastic or any metal selected from the group consisting of steel alloys, stainless steel, galvanized iron and aluminium. It will be appreciated by a person skilled in that art that the list provided is merely an example of the types of materials that the feeder can be made from, and can include other materials not expressly listed.

In one embodiment, the receptacle, open trough and bar or plurality of bars are made of plastic. Suitable plastics include polyvinylchloride, polypropylene, and polycarbonates. It will be apparent to the person skilled in the art that other plastics and polymers can be used to make the feeder and that the list provided merely serves as an example of the types of plastics and polymers.

The rear wall 115 and the two side walls, 120 and 120′, joining the front wall 110 and the rear wall 115 may also be a sheet of material that is complete and contains the feed within the receptacle 105. The complete sheets of material do not allow access to the receptacle and have substantially the same advantages as discussed hereinabove.

The open trough 125 projects outwardly beyond the front wall 110 from the lower end of the receptacle 130. The positioning of the open trough 125 combined with the complete and sealed front wall 110 results in the feed being accessible only from the open trough 125. This set-up ensures that the livestock must eat from the lowest point of the feeder and are therefore encouraged to eat in their natural feeding position. Further to this, the open trough 125 acts as a catchment for any feed that falls from the receptacle 105. The position of the open trough 125 allows the livestock to gain access to the feed without needing to thrust its face into the receptacle and having feed potentially damaging its eyes.

The novelty of the feeder also lies in the angle between the opening of the open trough 125 (e.g. where the livestock eats) and the front wall 110. The opening of the open trough 125, relative to the front wall 110 forms an angle suitably between about 90° and 170°, more suitably about 100° and about 160°, and preferably about 110° and about 150°. The angle of the opening of the open trough in relation to the front wall 110 is important because it ensures that the livestock must feed in their natural feeding position.

In one embodiment, the feeder 100 may also comprise a bar or a plurality of bars 140, The plurality of bars is suitably from 1 to 10, and preferably selected from 2, 3, or 4 and most, suitably 3. It will be appreciated that the plurality of bars will vary with the dimensions of the trough, for example, if the trough is larger the plurality of bars will increase and may exceed 10. Depending on the type of feed, the number of bars may be altered to regulate the rate at which the feed is supplied to the livestock.

The bar or plurality of bars 340 comprise an upper portion 145 and a lower portion 150. The upper portion 145 of the bar or plurality of bars is attached to the lower end of the front wall 130, so that the animal cannot remove the bar or plurality of bars 140 and gain unrestricted access to the feed. The upper portion 145 extends from the lower end of the front wall 130 in substantially the same plane as the front wall 110, and the lower portion 150 curves outwardly in the same direction as the open trough 125 and covers the area between the lower end of the front wall 130, adjacent to the open trough 125, and an outer extent of the open trough 125. In this position, the grazing animal does not have unrestricted access to the feed because of the bar or plurality of bars 140. The bar or plurality of bars 140 also act to regulate the rate at which the feed is delivered from the receptacle chamber to the open trough 125. The bars or plurality of bars 140 also prevents the livestock from pulling out large flakes of hay which may then be largely dropped to the ground.

The bars also prevent the livestock from gaining access to the feed located at the bottom of the trough directly. Any sand or dirt that is carried with the feedstock will sift down to the bottom of the trough where the livestock does not have access. This alleviates the problems associated with consumption of dirt and sand, and the related problem of colic.

Typical feeders use a grille that covers the entire front surface of the feeder and do not utilize a complete and sealed front wall this poses a risk of the feed irritating and poking the grazing animal's eyes. Typical feeders also allow the livestock to feed in an unnatural head raised position because the front wail is not enclosed, in this set-up the livestock simply pulls the feed front the front wall grille and does not eat from the lower point of the feeder. The livestock will extend its neck to get to the feed from the grille and this positioning does not encourage them to eat in their natural feeding position.

It will be appreciated that the bar or plurality of bars 140 may also be embodied as a grid which can also regulate the amount of feed that is supplied to the livestock, and protect the livestock's eyes.

Referring to FIG. 2, the receptacle 105 has an open upper extent 205 beyond the upper extent of rear wall 135 and results in an extension of the open upper extent 205. This enlarged opening is advantageous because it is easier to load the feed into the receptacle 105.

One disadvantage of prior art feeders which do not utilize solid front wall, rear wall and side walls is that the feedstock is not protected from precipitation. The receptacle 105 may further comprise a lid. It will be appreciated that the lid may either be attached to the receptacle 105 or may be completely removable. The lid serves to protect the feed from getting wet when there is precipitation, allowing the feed to be kept in the receptacle chamber until the rain passes.

The rear wall 115 of the receptacle 105 may also be equipped with a fastener 160, which may attach to the surroundings. In the present case the faster is embodied as a hook which can be attached to the railing or bars of a stable or paddock. Fasteners are well known in the art and can comprise a hook or clip which can couple to a bar or a rail. The fastener may further comprise a male portion which can couple with a complimentary fastener, such as a female portion. It will be appreciated that the fastener and the complimentary faster can be embodied in different forms and the fastener allows the receptacle to be placed at different heights to encourage livestock to eat in its natural position.

The present invention discloses a feeder which encourages livestock to eat in their natural position, regulates the rate at which the feed is available to the livestock, protects the livestock's eyes and alleviates the problems associated with feed falling to the ground and thus the problems associated with colic in horses.

1. A feeder comprising:
a. a receptacle having a front wall, a rear wall and two side walls joining the front wall and the rear wall to form a receptacle chamber; and
b. an open trough projecting outwardly beyond the front wall from a lower end of the receptacle and continuous with the receptacle chamber,
wherein the front wall is a solid panel preventing access therethrough to the receptacle chamber.

2. The feeder of claim 1, wherein the rear wall, the two side walls, and the open trough are each also a solid panel.

3. The feeder of claim 2, wherein the solid panels are single integral panels or comprise multiple joined panels.

4. The feeder of claim 2, wherein the solid panels are each made of a plastic or a metal, or a combination thereof.

5. The feeder of claim 4, wherein the metal is selected from the group consisting of steel, alloys, stainless steel, galvanized iron, and aluminium.

6. The feeder of claim 5, wherein the plastic is selected from the group consisting of polyvinylchloride, polypropylene, and polycarbonates.

7. The feeder of claim 1, wherein the receptacle comprises at least one bar which extends between the lower extent of the front wall adjacent to the open trough, and an outer extent of the open trough.

8. The feeder of claim 1, wherein the receptacle has an open upper extent continuous with the receptacle chamber.

9. The feeder of claim 1, wherein the feeder further comprises a fastener, allowing the feeder to be removably attached to a feed station.

10. The feeder of claim 9, wherein the fastener is a hook or clip, or may further comprise a male portion which can couple with a complimentary fastener, such as a female portion.
